(19) United States
(12) Patent Application Publication
(10) Pub. No.: US 2025/0328648 A1
(43) Pub. Date: Oct. 23, 2025

(54) SECURE BOOT KEY ROTATION

(71) Applicant: Semtech Corporation, Camarillo, CA (US)

(72) Inventor: Alex Jiang, Surrey (CA)

(21) Appl. No.: 19/180,850

(22) Filed: Apr. 16, 2025

Related U.S. Application Data
(60) Provisional application No. 63/636,353, filed on Apr. 19, 2024.

(51) Int. Cl. G06F 21/57; G06F 21/60; G06F 21/64

(52) U.S. Cl. CPC G06F 21/575; G06F 21/602; G06F 21/64

(57) ABSTRACT

A method and system for secure boot key rotations with a secret hardware key is disclosed. To securely update and rotate the secure boot key, a new secure boot key is generated outside of a device. The new secure boot key is signed with the old secure boot key and sent to the device. The device verifies the new secure boot key with the old secure boot key that it already has in read/writable persistent memory. If the verification is successful, the old secure boot key is replaced with the new secure boot key.

### CROSS-REFERENCE TO RELATED APPLICATIONS

The present application claims priority under 35 U.S.C. § 119 to U.S. Provisional Application No. 63/636,353, entitled “ENABLE UNLIMITED SECURE BOOT KEY ROTATIONS USING A SECRET HARDWARE KEY,” filed Apr. 19, 2024, the entirety of which is incorporated by reference herein.

### TECHNICAL FIELD

The described examples relate generally to systems, devices, and techniques for booting authentic firmware securely in a device and, in particular, to authenticate firmware and enable unlimited secure boot key rotations using a secret hardware key.

### BACKGROUND

Secure boot is a security feature found in many computing devices that uses cryptography to ensure that only authentic firmware will boot in the device. Secure boot is a foundational security feature that is often the root-of-trust for many other security features, after all without authentic firmware most other onboard security features could not be relied upon. Thus, the security strength of secure boot is paramount. Yet, conventional approaches do not rotate cryptographic keys used in secure boot design, which is at odds with best-security-practices. For example, cryptographic keys used in secure boot are static and fixed for the lifetime of the device, making them more likely to be compromised. If a cryptographic key is compromised, device security is unrecoverable; the only recourse in such scenarios, is to replace all devices in the field that contain the compromised key. The invention solves this problem by making the secure boot key updatable, which reduces the chance of a key compromise as well as allows key compromises to be remedied without replacing devices.

In general, secure boot ensures that only authentic firmware can run in a device. At a high level, the firmware is cryptographically verified and only allowed to run if the verification is successful.

As an initial matter, boot sequences can vary greatly in complexity and involve many boot stages, operating systems (OSs), virtualizations, applications, etc. Without loss of generality, the present disclosure describes a simplified boot sequence for purposes of illustration. It will be appreciated, however, that in other example, the techniques described herein may be applied to other boot sequences, includes those of greater complexity. In the illustrative simplified sequence, a device's bootloader runs on power-up and reads the firmware from a persistent storage (usually flash) and loads the firmware into its memory and runs the firmware. Secure boot augments this process by allowing the bootloader to use a cryptographic key to verify the firmware image as it loads the firmware into memory and only if the verification is successful will the bootloader run the firmware. If the verification fails, the bootloader will generally enter a boot loop or a firmware recovery mode. To perform verification, the firmware image must be augmented with a signature generated using a signing key.

The bootloader performing verification of the firmware image itself is normally assumed to be authentic, which can be accomplished by storing the bootloader code in ROM (Read-Only Memory). In essence, secure boot leverages the hardware ROM as a root-of-trust to establish the authenticity of all code running within the device. Secure boot can be extended to work with more complex boot chains by having each stage in the boot chain verify the next stage in the boot chain. The present disclosure describes the first stage in the boot chain with respect to storage in ROM; however, in other cases, writable non-volatile storage, such as flash memory, can be used to store and execute the second stage boot code, thereby allowing for configurability or additional security features.

A private signing key and a public verification key may form a key pair that is mathematically linked. In existing secure boot configurations, as illustrated in FIG. 1, the private signing key is held off-target and is used for signing firmware releases by an entity called signing server. The public verification key is embedded in the device. These keys are usually class keys, meaning that the same key pair can be used to protect an entire class of devices.

Within the device the secrecy of the public verification key is not an issue since it is a public key, but the integrity of the public verification key is paramount. Still referring to FIG. 1, current secure boot solutions usually store the public verification key in OTP (One-Time-Programmable) storage. Firmware running in the device can write data into OTP but cannot modify it afterwards. The immutable nature of OTP provides integrity to the public verification key but at the cost of making it non-updatable. Secure boot designs may contain multiple layers of cryptographic keys but the key at the bottom layer is always in OTP as described.

However, with a non-updatable secure boot key, key rotation cannot be accomplished easily. This means that if a private signing key is compromised, device security may be unrecoverable; in such scenario, the only recourse may be to replace all devices in the field that contain the compromised key.

Alternatively, implementations of secure boot that use a multilayer signature scheme may support a limited number of rotations of upper layer keys but almost never supports the rotations of the key at the lowest layer, which can be referred to as the secure boot key. In the rare implementations where the secure boot key can be rotated, only a limited number of rotations within a predefined fixed set of secure boot keys is possible. This set of secure boot keys must be generated all at once and stored in the device during initial provisioning, which limits the number of rotations possible and makes securely storing the private secure boot keys difficult.

For example, an NXP Layerscape device supports secure boot with multiple keys. The NXP chip can store up to four secure boot keys in the OTP and use a separate set of OTP flags to control which of the four keys can be used, which allows up to three keys to be revoked. However, all four keys must be generated during the initial provisioning step. This complicates the private key storage strategy in the signing server. Therefore, a simpler solution is needed to generate and securely store the secure boot keys.

### SUMMARY

In one example, a method for securely rotating a plurality of boot keys with a hardware key is disclosed. The method comprises generating, by a signing server, a first key pair of the plurality of boot keys, wherein the first key pair includes a first public verification key and a first private signing key; generating, by the signing server, a first signature by using the first private signing key and a first firmware image; booting, by a bootloader of an electric device, the electric device to run the first firmware image by using the electric device's first key pair; and rotating, by the bootloader of the electric device, the first key pair of the plurality of boot keys.

In another example, the method further comprises generating, by the signing server, a second key pair of the plurality of boot keys, wherein the second key pair includes a second public verification key and a second private signing key; generating, by the signing server, a second signature and a third signature by using the second key pair and a second firmware image, wherein the second signature is associated with the second firmware image; updating, by the bootloader of the electric device, the first key pair and the first firmware image with the second key pair and the second firmware image; verifying, by the bootloader of the electric device, the second signature by using the second public verification key; and loading, by the bootloader of the electric device, the second firmware image.

In another example, booting the electric device to run the first firmware image further comprises storing the first signature, the first firmware image, and the first public verification key into the electric device's storage; verifying the electric device is set to a secure boot mode; generating a first message authentication code for the first public verification key by using the hardware key; storing the first message authentication code into the electric device's storage; verifying the first signature by using the first public verification key; and loading the first firmware image to the electric device.

In another example, generating the second signature and the third signature further comprises generating the second signature by using the second private signing key and the second firmware image; generating the third signature by using the second public verification key and the first private signing key; replacing the first private signing key with the second private signing key; destroying the first private signing key; and storing the second signature, the third signature, the second public verification key, and the second firmware image into the electric device's storage.

In another example, updating the first key pair and the first firmware image with the second key pair and the second firmware image can be achieved by rebooting the electric device; verifying the electric device is set to a secure boot mode; verifying a first message authentication code in the electric device's storage; verifying the first public verification key by using the hardware key; verifying the third signature by using the first public verification key; replacing the first public verification key with the second public verification key; generating a second message authentication code for the second public verification key by using the hardware key; and replacing the first message authentication code with the second message authentication code.

In another example, the hardware key is embedded in the electric device's hardware during wafer production.

In another example, the first message authentication code and the second message authentication code each is generated by using one of a plurality of algorithms, including but not limited to hash-based message authentication code, one-key message authentication code, cipher-based message authentication code, Galois message authentication code, and parallelizable message authentication code.

In another example, verifying the electric device is set to the secure boot mode further comprises setting a first verification bit in a one-time-programmable storage and verifying the value of the first verification bit is equal to 1.

In another example, verifying the first message authentication code further comprises setting a second verification bit in a one-time-programmable storage; verifying the value of the second verification bit is equal to 1; and verifying the first message authentication code with the hardware key.

In another example, a system for securely rotating a plurality of boot keys with a hardware key is disclosed. The system includes a signing server and an electric device.

The signing server is configured to generate a first key pair of the plurality of boot keys comprising a first public verification key and a first private signing key, a second key pair of the plurality of boot keys comprising a second public verification key and a second private signing key, a first signature by using the first private signing key and a first firmware image, a second signature by using the second private signing key and a second firmware image, and a third signature by using the second public verification key and the first private signing key.

The electric device comprising a bootloader and a storage configured to rotate the first key pair with the second key pair.

In another example, the signing server is further configured to replace the first private signing key with the second private signing key and destroy the first private signing key.

In another example, the bootloader is further configured to verify the electric device is set to a secure boot mode; generate a first message authentication code for the first public verification key by using the hardware key; store the first message authentication code into the electric device's storage; verify the first signature by using the first public verification key; and load the first firmware image.

In another example, the bootloader is further configured to reboot the electric device; verify the electric device is set to a secure boot mode; verify the first public verification key by using the first message authentication code and the hardware key; verify the third signature by using the first public verification key; replace the first public verification key with the second public verification key; generate a second message authentication code for the second public verification key by using the hardware key; replace the first message authentication code with the second message authentication code; verify the second signature by using the second public verification key; and load the second firmware image.

In another example, the bootloader is further configured to set a first verification bit in a one-time-programmable storage and verify the value of the first verification bit is equal to 1.

In another example, the bootloader is further configured to set a second verification bit in a one-time-programmable storage; verify the value of the second verification bit is equal to 1; and verify the first message authentication code with the hardware key.

In addition to the example aspects described above, further aspects and examples will become apparent by reference to the drawings and by study of the following description.

### BRIEF DESCRIPTION OF THE DRAWINGS

FIG. 1 depicts an example secure boot key system.

FIG. 2 depicts another example secure boot key system in flash storage.

FIG. 3 depicts another example secure boot key system for new key pair generation.

FIG. 4 depicts another example secure boot key system for signing new key and firmware.

FIG. 5 depicts another example secure boot key system for new key and firmware delivery.

FIG. 6 depicts another example secure boot key system for verifying new key with old key.

FIG. 7 depicts another example secure boot key system for secure boot with new key.

FIG. 8 depicts a flow diagram of an exemplary initial key provisioning process.

FIG. 9 depicts a flow diagram of an exemplary secure boot process.

FIG. 10 depicts a flow diagram of an exemplary key rotation process.

FIG. 11 depicts a functional block diagram of a computing system.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates generally to a method and system for rotating secure boot keys by using a secret hardware key in a device. An exemplary embodiment of the invention can perform unlimited secure boot key rotations for a device. Key rotation is a critical security practice that help protect sensitive data and system by periodically replacing cryptographic keys. It can reduce the risk of unauthorized access to critical firmware images and operating systems resulting from compromised, exposed, or outdated keys. By systematically rotating the secure boot keys, organizations can maintain integrity and confidentiality of their systems.

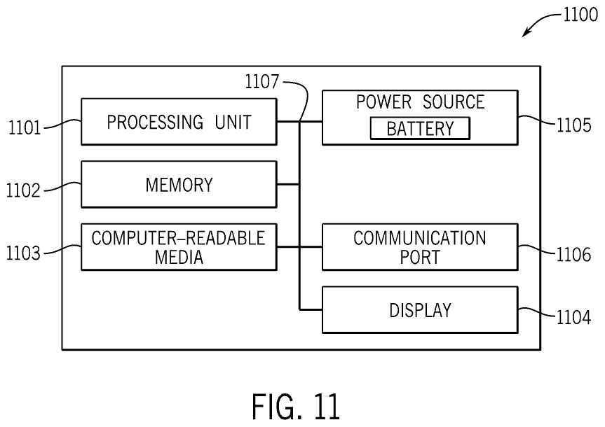

For purposes of illustration, the techniques disclosed herein may be implemented on substantially any electronic device having a boot sequence. For example, the techniques disclosed herein may be implement on the computing device or system, as illustrated in FIG. 11, which may include any appropriate hardware and software components for use in facilitating any appropriate operations disclosed herein. The secure boot keys, which are usually formed by a pair of a private signing key and a public verification key, can be generated on-demand for provisioning into the device, ensuring that at any given time, only a single private secure boot key needs to be stored securely. This makes securely storing the secure boot key simpler. During the key update process, a signing server generates a new pair of secure boot keys which include a new private signing key and a new public verification key. Then there will temporarily be two key pairs. To update (also called “rotate”) the secure boot keys, the new public verification key is signed with the current private signing key and then transferred to the device. The current private signing key can be replaced by the new private signing key in the signing server. After rebooting the device, the bootloader uses a secure hardware key to verify the current public verification key. It then uses the current public verification key to authenticate the signature of the new public verification key. Once both verifications are successful, the bootloader replaces the current public verification key with the new public verification key. With the new public verification key, the bootloader can authenticate the firmware image by verifying its digital signature. If the verification is successful, the bootloader can proceed to load and run the firmware.

Secure boot designs may implement multiple layers of keys. In the present disclosure, only the secure boot key at the bottom layer (sometimes called the root key) is discussed, since the root key is important as it anchors the chain of trust for a secure boot process.

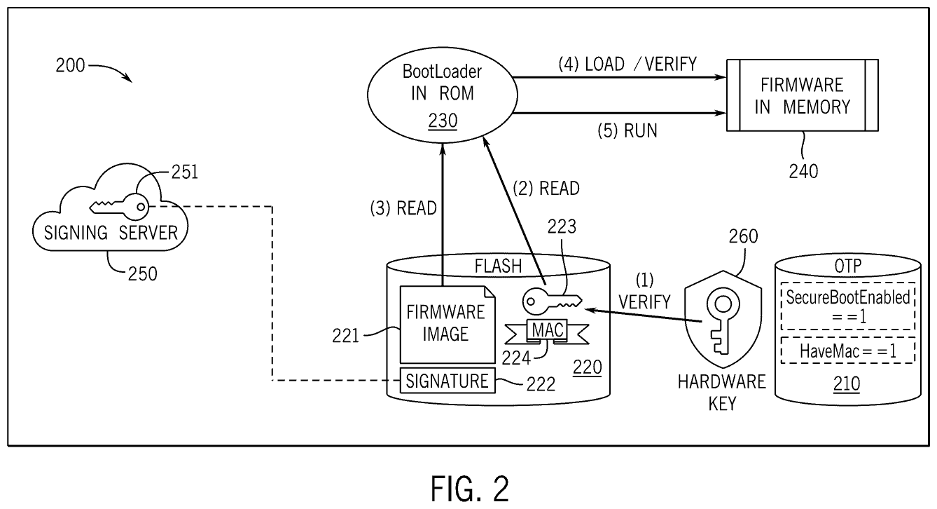

Turning to the Drawings, FIG. 2 depicts an example secure boot key system 200. The secure boot key system 200 can include a device (such as the device 1100 of FIG. 11) and a signing server 250. The device includes an OTP (One-Time-Programmable) storage 210, a read/writable storage (e.g., flash memory) 220, a read-only memory (ROM) 230, a memory 240, and a hardware key 260. As illustrated in FIG. 2, the ROM 230 contains the device's bootloader code so that the bootloader can be securely accessible and reliably executed immediately upon powering up the device. ROM 230 is a non-volatile memory, meaning it retains its contents even when the power if off, which is essential for the bootloader's role in initializing hardware and loading the firmware image. Storing the bootloader in ROM 230 ensures its integrity and security, preventing unauthorized modification or corruption, which is critical for trusted system startup. The signing server 250 can be a remote server computer or a cloud-based server. It is responsible for generating secure boot keys and securely storing private signing keys.

In some other examples, especially in some complex computing environments, the secure boot key system 200 may include a primary bootloader stored in ROM 230 and one or more secondary bootloaders in the read/writable storage (e.g., flash memory) 220 (not illustrated herein). The primary bootloader in ROM 230 can be configured to perform essential initialization tasking such as setting critical components, such as processor and memory, and verifying firmware images. The secondary bootloaders in the read/writable storage (e.g., flash memory) 220 are more feature-rich and flexible, often responsible for loading the full operating system or performing additional check on the device.

In the present disclosure, to support secure boot key rotations, the secure boot key system 200 may store a public verification key 223 in the read/writable storage (e.g., flash memory) 220 instead of an OTP (One-Time-Programmable) storage 210. To further maintain the integrity of the public verification key 223, a hardware secret key 260 can be used to verify the authentication of the public verification key 223, wherein the hardware secret key 260 is only accessible to a device's bootloader 230. Without loss of generality, the secret hardware key 260 can be obtained in various ways, such as being generated within an on-chip secure element, derived from a PUF (physically unclonable function), built directly into hardware, etc. The bootloader then uses the hardware key 260 to generate a MAC (Message Authentication Code) 224 of the public verification key 223 by using one of MAC algorithms, such as hash-based message authentication code (HMAC), one-key message authentication code (OMAC), cipher-based message authentication code (CMAC), Galois message authentication code (GMAC), and parallelizable message authentication code (PMAC). This MAC 224 can be stored in read/writable storage 220 and is used to verify the public verification key 223 during a boot process.

In a secure boot phase, the device's bootloader verify the public verification key 223 and the MAC 224 by using the hardware key 260. For example, FIG. 2 shows a process flow (1) VERIFY, during which the hardware key 260 is used to authenticate the public verification key 223 by verifying the associated MAC 224. Once the verification is successful, the bootloader can read the public verification key 223 in process flow (2) READ and the firmware image 221 in process flow (3) READ. Then the public verification key 223 is used to authenticate the firmware image 221 by verifying its signature 222. If the verification is successful, the bootloader can load the firmware image 221 into the memory 240 as depicted in process flow (4) LOAD/VERIFY and run it on the device, which is depicted in process flow (5) RUN. In the present disclosure, the memory 340 may refer to various types of read access memory (RAM), such as static read access memory (SRAM) or dynamic read access memory (DRAM) and is characterized as non-persistent.

Furthermore, as depicted in FIG. 2, the OTP (One-Time-Programmable) storage 210 is configured to contain two verification bits to indicate the operation mode and status of the device. For example, one OTP bit “SecureBootEnabled” is used to enable the device's secure boot feature and another OTP bit “HaveMac” is used to indicate whether or not a MAC value is available. Both bits can only transition from a 0 to a 1 and cannot transition from a 1 to a 0. In particular, the OTP bit “SecureBootEnabled” is set by external actions usually during the device manufacturing process. For example, in general, the OTP bit “SecureBootEnabled” can be set during the manufacturing process where the device is instructed to do so by a factory machine. This can technically be done at any time but for the purposes of secure boot it can only be done during the initial key provisioning. The OTP bit “HaveMac” is set internally by the bootloader to transition the bootloader's state. This can only be done during the initial key provisioning.

When the OTP bit “SecureBootEnabled” is set to 0, secure boot is not enabled on the device. Therefore, the device will boot the firmware image without verifying it. When the OTP bit “SecureBootEnabled” is set to 1, secure boot is enabled, and the device can either boot verified firmware or go into a recovery mode if the firmware verification fails. In addition, the OTP bit “HaveMac”=0 indicates that there is currently no MAC value for the public verification key 223. If a public verification key is present, then a MAC should be generated for it, and the OTP bit “HaveMac”should then be set to 1. When the OTP bit “HaveMac”=1, it indicates that MAC value should already exist, and so no MAC will be generated. However, if a MAC is not found when the OTP bit “HaveMac”=1, this triggers an error condition, causing the device to enter recovery mode.

This mechanism ensures that the bootloader cannot be tricked into generating a MAC value if a MAC value should already exist. But it still allows the initial MAC value to be generated appropriately.

To securely update the secure boot key, a new secure boot key is generated outside of the device, typically by a signing server. The signing server generates the new secure boot key and signs it by using the old secure boot key. The signed new secure boot key is then sent to the device via various options, such as USB, wired, wireless, or cloud transfer. The device verifies the new secure boot key with the old secure boot key that it already has in read/writable persistent memory. If the verification is successful, the old secure boot key is replaced with the new secure boot key, completing the key rotation process.

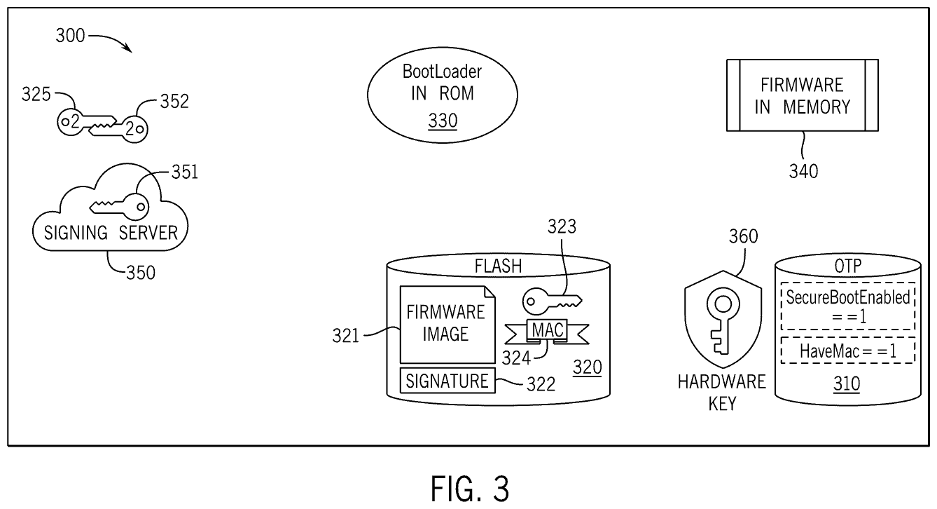

FIGS. 3 to 7 illustrate an example secure boot key rotation process where a new firmware image is updated at the same time. Note that updating the firmware and rotating the secure boot key at the same time is not strictly necessary but these operations would in general be performed together.

Turning to FIG. 3, an example secure boot key system 300 is shown whereby a signing server 350 is configured to generate a new secure boot key pair. The secure boot key system 300 can include a device (such as the device 1100 of FIG. 11) and a signing server 350, wherein the device can be remotely coupled to the signing server 350 via various options, such as wired, wireless, and cloud connections. The secure boot key system 300 may be substantially analogous to the secure boot key system 200 described above in relation to FIG. 2. In this regard, the secure boot key system 300 is shown in FIG. 3 as including an OTP storage 310, a read/writable storage (e.g., flash memory) 320, a ROM 330, a memory 340, a signing server 350, and a hardware key 360; redundant explanation of which are omitted for clarity.

As illustrated in FIG. 3, the new secure boot key pair includes a new private signing key 352 containing the label “2” and a new public verification key 325 containing the label “2.” The signing server stores a current private signing key 351. The OTP storage 310 includes two bits “SecureBootEnabled” and “HaveMac,” which are both set to 1. The read/writable storage (e.g., flash memory) 320 is configured to store a current firmware 321 along with its signature 322, a current public verification key 323 and a current MAC 324. The device's bootloader is stored in the ROM 330. Firmware image is then loaded into the memory 340 for execution. In the present disclosure, the memory 340 may refer to various types of RAM, such as SRAM or DRAM, and is characterized as non-persistent.

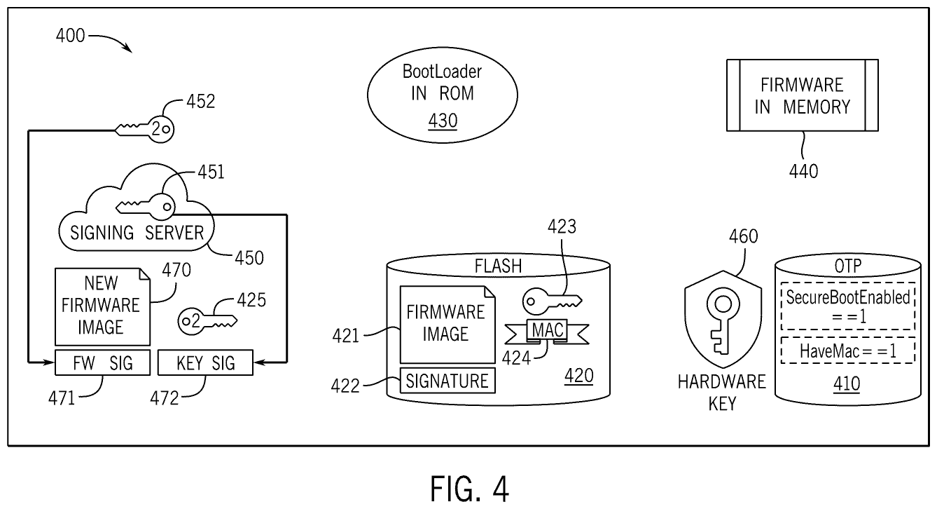

In FIG. 4, an example secure boot key system 400 is shown whereby a signing server 450 is configured to sign a new firmware image with the new private signing key 452 containing the label “2” while the new public verification key 425 containing the label “2” is signed with the old private signing key 451 of an old secure boot key pair. The secure boot key system 400 may be substantially analogous to the secure boot key system 300 described above in relation to FIG. 3. In this regard, the secure boot key system 400 is shown in FIG. 4 as including an OTP (One-Time-Programmable) storage 410, a read/writable storage (e.g., flash memory) 420, a read-only memory (ROM) 430, a memory 440, a signing server 450, and a hardware key 460; redundant explanation of which are omitted for clarity.

Signing the new public verification key 425 with the old private signing key, which is the current private signing key 451 stored in the signing server 450, is important as it allows the device to authenticate the new public verification key 425. Without loss of generality, any digital signature algorithm can be used to generate the key signature 472, such as the Elliptic Curve Digital Signature Algorithm (ECDSA), Rivest-Shamir-Adleman (RSA), SPHINCS+, Dilithium, etc. These algorithms use a pair of keys that are mathematically linked. One key is called the private key, and the other is called the public key. The private key must be kept secret, and the public key can be made public. The private key is used to generate a signature on a message (a process called signing). The message can be any variable length, arbitrary data. The public key is used to verify the signature on the message. If the verification is successful, it is assured that the message was signed by the holder of the private key and that the message was not modified in any way.

Similarly, a new firmware image can be updated, as discussed in FIG. 3, and signed with the new private signing key. Without loss of generality, the signing server 450 can use a plurality of digital signature algorithms, such as the Elliptic Curve Digital Signature Algorithm (ECDSA), Rivest-Shamir-Adleman (RSA), SPHINCS+, Dilithium, etc., to generate the firmware signature 471.

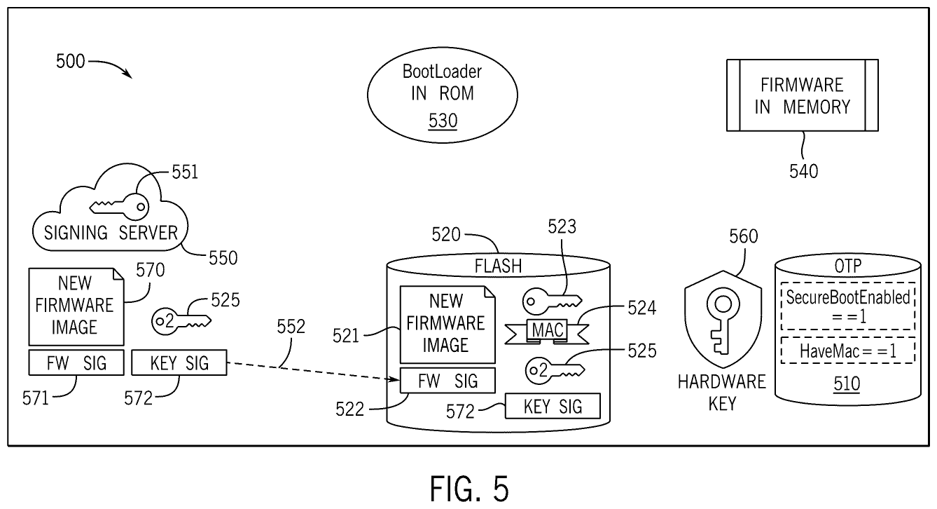

As illustrated in FIG. 5, an example secure boot key system 500 is shown whereby a signing server 550 is configured to deliver a new public verification key 525 containing the label “2” and a new firmware image 570 to the device. The secure boot key system 500 can include a device (such as the device 1100 of FIG. 11) and a signing server 550, wherein the device can be remotely coupled to the signing server 550 via various options, such as wired, wireless, and cloud connections. The secure boot key system 500 may be substantially analogous to the secure boot key system 400 described above in relation to FIG. 4. In this regard, the secure boot key system 500 is shown in FIG. 5 as including an OTP (One-Time-Programmable) storage 510, a read/writable storage (e.g., flash memory) 520, a read-only memory (ROM) 530, a memory 540, a signing server 550, and a hardware key 560; redundant explanation of which are omitted for clarity.

Once the signing operations are complete, the signing server 550 can send the new public verification key 525 and its signature 572 to the device via one or more transmission links 552. Without loss of generality, the one or more transmission links 552 can be established by one or more different options, such as USB transfer, wired connection, wireless connection, or cloud transfer. The old private signing key, which is the current private signing key 451 in FIG. 4, can be destroyed and replaced with the new private signing key 551 containing the label “2” in the signing server 550. Similarly, the signing server 550 can send the new firmware image 570 and its signature 571 to the device via the same transmission links 552. In general, the new firmware image 570 and its signature 571 may replace the old firmware image and its signature before rebooting the device, which can be illustrated in FIG. 5 as the new firmware image 521 and the signature 522. Alternatively, the device have multiple boot partitions within its read/writable storage (e.g., flash memory) 520, so that both the new and old firmware images can be available.

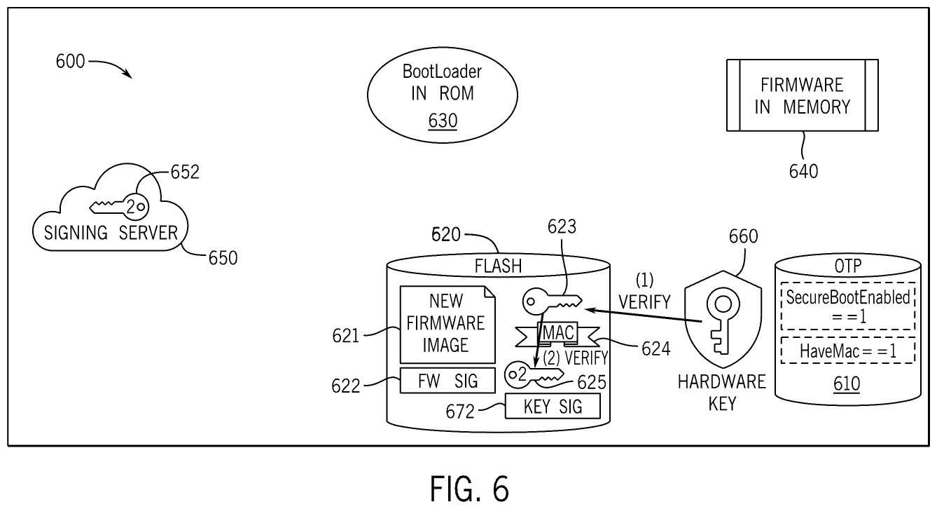

Turning to FIG. 6, an example secure boot key system 600 is shown whereby a device's bootloader is configured to verify the new public verification key 625 containing the label “2” with the current public verification key 623. The secure boot key system 600 can include a device (such as the device 1100 of FIG. 11) and a signing server 650, wherein the device can be remotely coupled to the signing server 650 via various options, such as wired, wireless, and cloud connections. The secure boot key system 600 may be substantially analogous to the secure boot key system 500 described above in relation to FIG. 5. In this regard, the secure boot key system 600 is shown in FIG. 6 as including an OTP (One-Time-Programmable) storage 610, a read/writable storage (e.g., flash memory) 620, a read-only memory (ROM) 630, a memory 640, a signing server 650, and a hardware key 660; redundant explanation of which are omitted for clarity.

As illustrated in FIG. 6, the signing server 650 stores the new private signing key 652 that contains the label “2.” The device's bootloader is configured to first verify the current public verification key 623 with the hardware key 660. In particular, the process flow (1) VERIFY shows that the bootloader uses the hardware key 660 to verify the current MAC 624 associate with the current public verification key 623. Then the bootloader is configured to verify the new public verification key 625 with the current public verification key 623, which is depicted in the process flow (2) VERIFY. If both verifications succeed, the current public verification key 623 is overwritten with the new public verification key 625. If either verification fails, the bootloader will enter a boot loop or recovery mode to prevent unauthorized access or tampering.

Then the bootloader can use the hardware key 660 with the new public verification key 625 to generate a new MAC 624 to replace the current (old) MAC. The MAC can be generated by using one of MAC generation algorithms, such as hash-based message authentication code (HMAC), cipher-based message authentication code (CMAC), Galois message authentication code (GMAC), etc. In any implementation instance the MAC generation algorithm would be fixed and either embedded in the bootloader code or a part of the device's hardware.

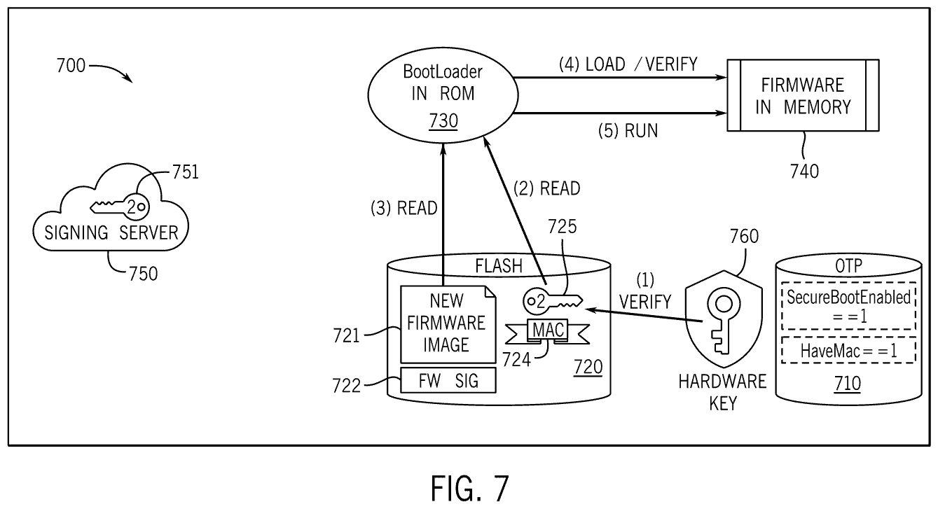

FIG. 7 illustrates an example secure boot key system 700 configured to load and run the new firmware image. The secure boot key system 700 can include a device (such as the device 1100 of FIG. 11) and a signing server 750, wherein the device can be remotely coupled to the signing server 750 via various options, such as wired, wireless, and cloud connections. The secure boot key system 700 may be substantially analogous to the secure boot key system 600 described above in relation to FIG. 6. In this regard, the secure boot key system 700 is shown in FIG. 7 as including an OTP (One-Time-Programmable) storage 710, a read/writable storage (e.g., flash memory) 720, a read-only memory (ROM) 730, a memory 740, a signing server 750, and a hardware key 760; redundant explanation of which are omitted for clarity.

The secure boot key rotation is complete at this point, and the secure boot process happens as described earlier using the new public verification key 725 which contains the label “2” to verify the new firmware image 721. Similar to FIG. 2, FIG. 7 shows a process flow (1) VERIFY, during which the hardware key 760 is used to authenticate the public verification key 725 by verifying the associated MAC 724. Once the verification is successful, the bootloader can read the public verification key 725 in process flow (2) READ and the new firmware image 721 in process flow (3) READ. Then the public verification key 725 is used to authenticate the new firmware image 721 by verifying its signature 722. If the verification is successful, the bootloader can load the new firmware image 721 in the memory 740 as depicted in process flow (4) LOAD/VERIFY and run it on the device, which is depicted in process flow (5) RUN. If the verification fails, the bootloader can enter a boot loop or a recovery mode.

In general, there are essentially three phases to an example secure boot solution: initial key provisioning, boot and key rotation. Looking at the behavior of the bootloader in these three phases will clarify how this secure boot solution works.

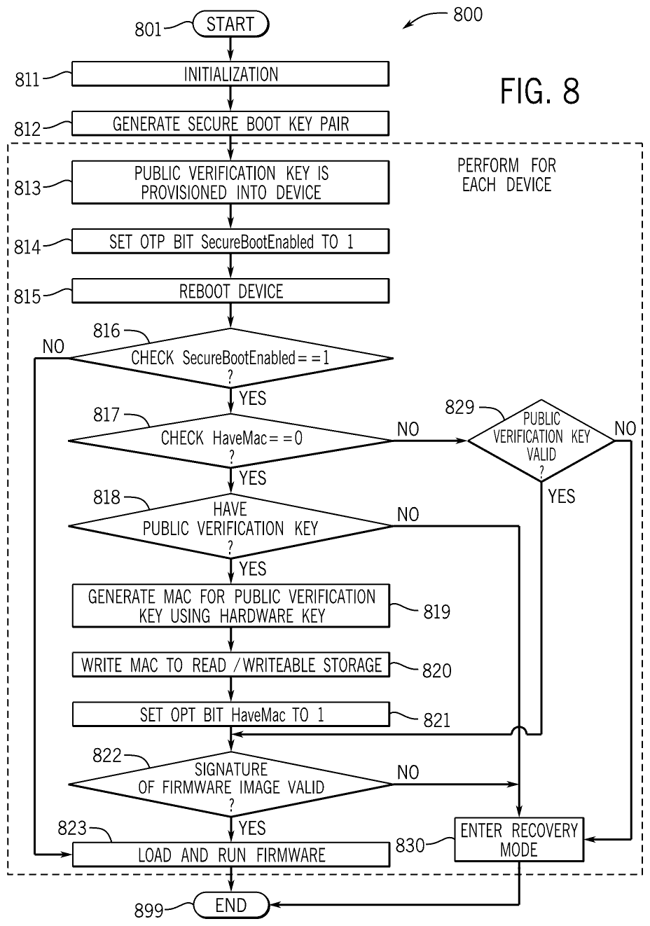

FIG. 8 depicts a flow diagram of an exemplary initial key provisioning process 800 in a secure boot key system. The secure boot key system, as depicted in FIGS. 2-7, can include a device and a signing server. The device includes an OTP storage, a read/writable storage (e.g., flash memory), a read-only memory (ROM), a memory, and a hardware key. The process 800 normally happens in the factory and starts at step 801.

At step 811, the device (such as the device in FIG. 2) in the secure boot key system is initialized. For example, the secure boot is not enabled, which means both the OTP bits “SecureBootEnabled” and “HaveMac” are 0s. The hardware key (such as the hardware key 260 in FIG. 2) is already embedded into the device's hardware. This is usually done by the chip FAB during wafer production.

At step 812, the signing server (such as the signing server 250 in FIG. 2) in the secure boot key system is configured to generate a secure boot key pair, which includes a private signing key (such as the private signing key 251 in FIG. 2) and a public verification key (such as the public verification key 223 in FIG. 2). The private signing key can be held securely in the signing server, ideally in an HSM (Hardware Security Module). The public verification key can be extracted for later use. This step only needs to be done once for a class of devices.

At step 813, the signing server (such as the signing server 250 in FIG. 2) can send the public verification key to the device via various options, such as USB, wired, wireless, and cloud transfer. The device is configured to store the public verification key in a predefined location in its read/writable storage (such as the read/writable storage (e.g., flash memory) 220 in FIG. 2).

At step 814, the OTP bit “SecureBootEnabled” is changed from 0 to 1 so that when the device is rebooted, it will work in a secure boot mode. In general, the OTP bit “SecureBootEnabled” can be set during the manufacturing process where the device is instructed to do so by a factory machine. The process 800 then proceeds to step 815.

At step 815, the device can be rebooted so that it can work on the secure boot mode. For example, in the manufacturing factory, the factory equipment can instruct the device to reboot. The process 800 then proceeds to step 816.

At step 816, the device's bootloader (such as the bootloader in ROM 230 in FIG. 2) will check the value of the OTP bit “SecureBootEnabled.” If it is not 1, the secure boot is not enabled. The bootloader may proceed directly to step 823 to load and run the firmware image. If it is 1, the process 800 then proceeds to step 817.

At step 817, the bootloader (such as the bootloader in ROM 230 in FIG. 2) will check the value of the OTP bit “HaveMac.” The initial value of the OTP bit “HaveMac” is set to 0. If it is not 0, then the bootloader expects that there is a public verification key and a corresponding MAC present. Then the bootloader proceeds to step 829 to verify the public verification key. If it is 0, then the process 800 proceeds to step 818.

At step 829, the bootloader (such as the bootloader in ROM 230 in FIG. 2) will verify the public verification key by using the MAC and the hardware key. If the verification succeeds, then the process 800 proceeds to step 822. If the verification fails, then the bootloader will enter a boot loop or a recovery mode 830.

At step 818, the bootloader (such as the bootloader in ROM 230 in FIG. 2) will check the device's read/writable storage (e.g., flash memory 220 in FIG. 2) and see if there is a public verification key. If there is a public verification key available, the process 800 proceeds to step 819 to generate a MAC. Otherwise, the bootloader will enter a boot loop or a recovery mode 830.

At step 819, the bootloader (such as the bootloader in ROM 230 in FIG. 2) finds that there is a public verification key available. It can use the hardware key to generate a MAC of the public verification key. In particular, the MAC can be created by the bootloader by using one of MAC generation algorithms, such as hash-based message authentication code (HMAC), one-key message authentication code (OMAC), cipher-based message authentication code (CMAC), Galois message authentication code (GMAC), parallelizable message authentication code (PMAC), etc. In any implementation instance, the MAC generation algorithm would be fixed and either embedded in the bootloader code or a part of the device's hardware.

At step 820, the bootloader (such as the bootloader in ROM 230 in FIG. 2) can store the MAC in the device's read/writable storage (e.g., flash memory 220 in FIG. 2) alongside the public verification key. The process 800 then proceeds to step 821.

At step 821, the bootloader (such as the bootloader in ROM 230 in FIG. 2) change the OTP bit “HaveMac” from 0 to 1. As discussed before, both OTP bits “SecureBootEnabled” and “HaveMac” can only transition from 0 to 1 but cannot transition from 1 to 0.

At step 822, the bootloader (such as the bootloader in ROM 230 in FIG. 2) can use the public verification key to verify the signature of the firmware image. If verification fails, the bootloader enters a boot loop or a recovery mode 830. Otherwise, the process 800 then proceeds to step 823.

At step 823, the bootloader (such as the bootloader in ROM 230 in FIG. 2) is configured to read the firmware image and load it from the memory. The bootloader can run the firmware image on the device. In some other examples, the bootloader can offload loading and running tasks to secondary bootloaders in the device. The steps 813 to 823 are performed on each device. The process 800 finally ends at step 899.

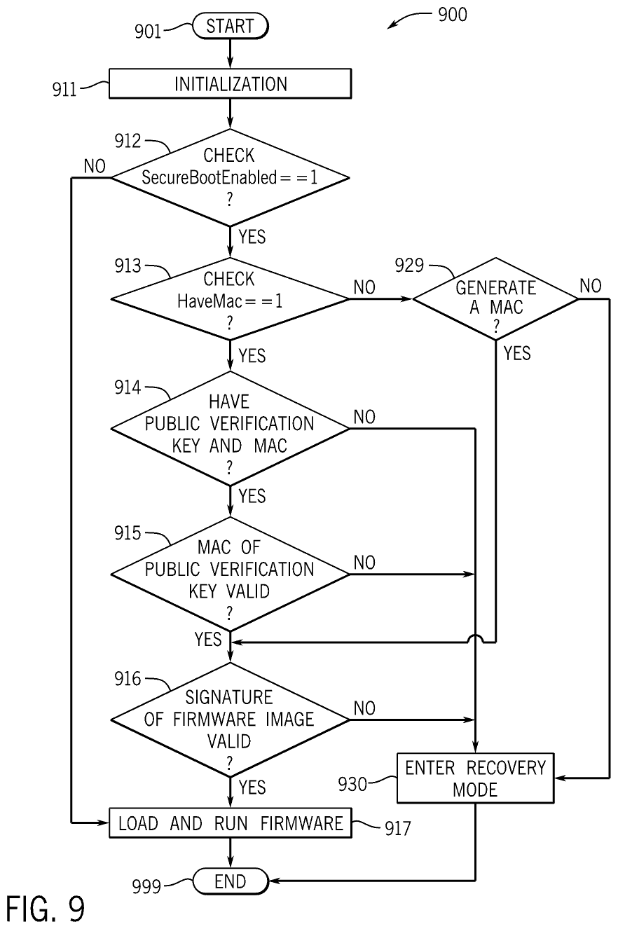

FIG. 9 depicts a flow diagram of an exemplary secure boot process 900 in a secure boot key system. The secure boot key system, as depicted in FIGS. 2-7, can include a device and a signing server. The device includes an OTP storage, a read/writable storage (e.g., flash memory), a read-only memory (ROM), a memory, and a hardware key. The process 900 starts at step 901.

At step 911, the device is powered on to initialize. The process 900 then proceeds to step 912.

At step 912, the device's bootloader (such as the bootloader in ROM 230 in FIG. 2) checks the value of OTP bit “SecureBootEnabled” and sees if it is 1. If it is, then the device is operated in secure boot mode and the process 900 can proceed to step 913. Otherwise, the bootloader proceeds directly to step 917 to load and run the firmware image.

At step 913, the bootloader (such as the bootloader in ROM 230 in FIG. 2) further checks the value of OTP bit “HaveMac” and sees if it is 1. Normally, after the initial bit provisioning process, the OTP bit “HaveMac” should be set to 1 since there is a MAC of a current public verification key stored in the device's read/writable storage (e.g., flash memory 220 in FIG. 2). If it is 1, then the process 900 can proceed to step 914. Otherwise, the process 900 can proceed to step 929.

At step 929, the bootloader (such as the bootloader in ROM 230 in FIG. 2) will attempt to look for the public verification key and generate a MAC for it using the hardware key. If the MAC is successfully generated, the process 900 then proceeds to step 916. Otherwise, the bootloader may not find the public verification key and will enter a boot loop or a recovery mode 930.

At step 914, the bootloader (such as the bootloader in ROM 230 in FIG. 2) can access the device's read/writable storage (e.g., flash memory 220 in FIG. 2) and check whether or not there is a public verification key and a corresponding MAC. If either is missing, the bootloader enters a boot loop or a recovery mode 930. Otherwise, the process 900 proceeds to step 915.

At step 915, the bootloader (such as the bootloader in ROM 230 in FIG. 2) is configured to use the hardware key to verify the MAC of the public verification key. If verification fails, the bootloader enters a boot loop or a recovery mode 930. Otherwise, the process 900 proceeds to step 916.

At step 916, after verifying the public verification key, the bootloader (such as the bootloader in ROM 230 in FIG. 2) uses it to verify the signature of the firmware image. If verification fails, the bootloader enters a boot loop or a recovery mode 930. Otherwise, the process 900 proceeds to step 917.

At step 917, the bootloader (such as the bootloader in ROM 230 in FIG. 2) is configured to read the firmware image and load it from the memory. The bootloader can run the firmware image on the device. In some other examples, the bootloader can offload loading and running tasks to secondary bootloaders in the device. The process 900 finally ends at step 999.

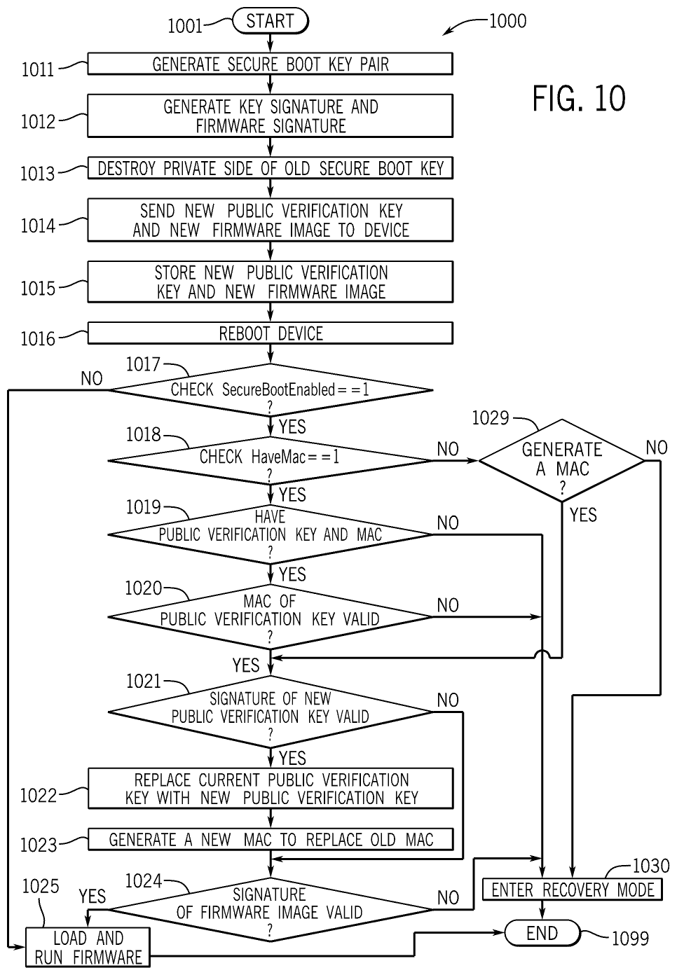

FIG. 10 depicts a flow diagram of an exemplary key rotation process 1000 in a secure boot key system. The secure boot key system, as depicted in FIGS. 2-7, can include a device and a signing server. The device includes an OTP storage, a read/writable storage (e.g., flash memory 220 in FIG. 2), a read-only memory (ROM), a memory, and a hardware key. The process 1000 starts at step 901.

At step 1011, the signing server (such as the signing server 350 in FIG. 3) of the secure boot key system is configured to generate a new key pair. The new key pair includes a new private signing key (such as the new private signing key 352 in FIG. 3) and a new public verification key (such as the new public verification key 325 in FIG. 3). The process 1000 then proceeds to step 1012.

At step 1012, the signing server (such as the signing server 450 in FIG. 4) is configured to sign the new public verification key (such as the new public verification key 425 in FIG. 4) with the current private signing key (such as the current private signing key 451 in FIG. 4). As discussed in FIG. 4, without loss of generality, any digital signature algorithm can be used to generate the key signature (such as the key signature 472 in FIG. 4), such as the Elliptic Curve Digital Signature Algorithm (ECDSA), Rivest-Shamir-Adleman (RSA), SPHINCS+, Dilithium, etc. These algorithms use a pair of keys that are mathematically linked. One key is called the private key, and the other is called the public key. The private key must be kept secret, and the public key can be made public. The private key is used to generate a signature on a message (a process called signing). The message can be any variable length, arbitrary data. The public key is used to verify the signature on the message. If the verification is successful, it is assured that the message was signed by the holder of the private key and that the message was not modified in any way.

Similarly, the signing server (such as the signing server 450 in FIG. 4) can be configured to sign a new firmware image (such as the new firmware image 470 in FIG. 4) with the new private signing key (such as the new private signing key 452 in FIG. 4). Without loss of generality, the signing server can use a plurality of digital signature algorithms, such as the Elliptic Curve Digital Signature Algorithm (ECDSA), Rivest-Shamir-Adleman (RSA), SPHINCS+, Dilithium, etc., to generate the firmware signature (such as the firmware signature 471 in FIG. 4).

At step 1013, the signing server (such as the signing server 550 in FIG. 5) can be configured to replace the current (old) private signing key with the new private signing key (such as the new private signing key 551 in FIG. 5). Afterward, it can destroy the current (old) private signing key. Then the process 1000 proceeds to step 1014.

At step 1014, the signing server (such as the signing server 550 in FIG. 5) can send the new public verification key (such as the new public verification key 525 in FIG. 5) and its signature (such as the key signature 572 in FIG. 5) to the device via various options (such as the transmission links 552 in FIG. 5), including USB, wired, wireless, and cloud transfer. In addition, the signing server can also deliver the new firmware image (such as the new firmware image 570 in FIG. 5) and its signature (such as the firmware signature 571 in FIG. 5) to the device via various options (such as the transmission links 552 in FIG. 5), including USB, wired, wireless, and cloud transfer. Then the process 1000 proceeds to step 1015.

At step 1015, the device is configured to store the new public verification key (such as the new public verification key 525 in FIG. 5) and its signature (such as the key signature 572 in FIG. 5) in a predefined location in its read/writable storage (e.g., flash memory 520 in FIG. 5). In addition, the device can store the new firmware image (such as the new firmware image 521 in FIG. 5) and its signature (such as the firmware signature 522 in FIG. 5) in a predefined location in its read/writable storage (e.g., flash memory 520 in FIG. 5).

At step 1016, the device can be rebooted to enter secure boot mode. In this way, the device can load and run the new firmware image after key update and verification.

At step 1017, the device's bootloader (such as the bootloader in ROM 630 in FIG. 6) checks the value of OTP bit “SecureBootEnabled” and sees if it is 1. If it is, then the device is operated in secure boot mode and the process 1000 can proceed to step 1018. Otherwise, the bootloader proceeds directly to step 1025 to load and run the firmware image.

At step 1018, the bootloader (such as the bootloader in ROM 630 in FIG. 6) further checks the value of OTP bit “HaveMac” and sees if it is 1. Normally, the OTP bit “HaveMac” should be 1 since there is a MAC of the current public verification key stored in the device's read/writable storage (e.g., flash memory 620 in FIG. 6). If it is 1, then the process 1000 can proceed to step 1019. Otherwise, the process 1000 can proceed to step 1029.

At step 1029, the bootloader (such as the bootloader in ROM 630 in FIG. 6) will attempt to look for the public verification key and generate a MAC for it using the hardware key. If it succeeds, then the process 1000 will proceed to step 1021. Otherwise, the bootloader may fail to find the public verification key and will enter a boot loop or a recovery mode 1030.

At step 1019, the bootloader (such as the bootloader in ROM 630 in FIG. 6) can access the device's read/writable storage (e.g., flash memory 620 in FIG. 6) and check whether or not the current public verification key (such as the current public verification key 623 in FIG. 6) and its MAC (such as the MAC 624 in FIG. 6) exist. If either is missing, the bootloader enters a boot loop or a recovery mode 1030. Otherwise, the process 1000 proceeds to step 1020.

At step 1020, the bootloader (such as the bootloader in ROM 630 in FIG. 6) is configured to use the hardware key (such as the hardware key 660 in FIG. 6) to verify the MAC (such as the MAC 624 in FIG. 6) of the current public verification key (such as the current public verification key 623 in FIG. 6). For example, this step is illustrated in FIG. 6 as process flow (1) VERIFY. If verification fails, the bootloader enters a boot loop or a recovery mode 1030. Otherwise, the process 1000 proceeds to step 1021.

At step 1021, the bootloader (such as the bootloader in ROM 630 in FIG. 6) is configured to detect the new public verification key (such as the new public verification key 625 in FIG. 6) in the device's read/writable storage (e.g., flash memory 620 in FIG. 6). As discussed in FIG. 6, the bootloader in ROM 630 is configured to use the current public verification key 623 to verify the signature 672 of the new public verification key 625. This step is illustrated as process flow (2) VERIFY. If verification fails, the bootloader ignores the new public verification key and maintains the current public verification key. The process 1000 then jumps to step 1024. Otherwise, the process 1000 proceeds to step 1022.

At step 1022, when the signature of the new public verification key is authenticated, the bootloader (such as the bootloader in ROM 630 in FIG. 6) is configured to replace the current public verification key (such as the current public verification key 623 in FIG. 6) with the new public verification key (such as the new public verification key 625 in FIG. 6). The process 1000 then proceeds to step 1023.

At step 1023, based on the new public verification key (such as the new public verification key 725 in FIG. 7), the bootloader (such as the bootloader in ROM 730 in FIG. 7) is configured to generates a new MAC (such as the MAC 724 in FIG. 7) over the new public verification key (such as the new public verification key 725 in FIG. 7) by using the hardware key (such as the hardware key 760 in FIG. 7). Then the bootloader replaces the current (old) MAC with this new MAC. The process 1000 then proceeds to step 1024.

At step 1024, the bootloader (such as the new public verification key 725 in FIG. 7) is configured to use the public verification key (such as the public verification key 725 in FIG. 7) to verify the signature (such as the firmware key 722 in FIG. 7) of the new firmware image (such as the new firmware image 721 in FIG. 7). In another example, if the signature of the new public verification key is invalid as discussed at step 1021, then the bootloader may be configured to ignore the new public verification key and use the current public verification key to verify the firmware image. In general, only the new firmware image is available because the old firmware image was overwritten by the new firmware image before the reboot of the device. Alternatively, the device may have more than one boot partitions, so that both the new and old firmware images can be available. When the verification of the new firmware image fails, the bootloader can switch to and verify the old firmware image. If the verification of the firmware image fails, the bootloader enters a boot loop or a recovery mode 1030. Otherwise, the process 1000 proceeds to step 1025.

At step 1025, the bootloader (such as the new public verification key 725 in FIG. 7) is configured to read the new firmware image and load it from the memory (such as the firmware in memory 740 in FIG. 7). The bootloader can run the new firmware image on the device. In some other examples, the bootloader can offload certain loading and running tasks to secondary bootloaders in the device. The process 1000 finally ends at step 1099.

FIG. 11 presents an illustrative computing system 1100. The schematic representation in FIG. 11 is generally representative of any types of systems and configurations that may be used for secure boot key rotations in accordance with the embodiments described herein. For example, the computing system 1100 may be used with or included within any of transceivers, computers, or computer modules described herein. In this regard, the computing system 1100 may include any appropriate hardware (e.g., computing devices, data centers, switches), software (e.g., applications, system programs, engines), network components (e.g., communication paths, interfaces, routers) and the like (not necessarily shown in the interest of clarity) for use in facilitating any appropriate operations disclosed herein. In this regard, it is contemplated that the computing system may perform secure boot key rotations with a hardware key. While the current disclosure refers to a specific embodiment of key rotations during a boot sequence of a particular device, it will be understood that the key rotation processes described herein may be performed on substantially any other electronic device having a boot sequence, such as desktop computers, laptop computers, tablets, smartphones, embedded systems, Internet-of-Things (IoT) devices, network routers, smart appliances, industrial control systems, automatic control units, and other computing platforms capable of executing firmware image, operating systems, or software.

As shown in FIG. 11, the computing system 1100 may include a processing unit or element 1101 operatively connected to computer memory 1102 and computer-readable media 1103. The processing unit 1101 may be operatively connected to the memory 1102 and computer-readable media 1103 components via an electronic bus or bridge (e.g., such as system bus 1107). The processing unit 1101 may include one or more computer processors or microcontrollers that are configured to perform operations in response to computer-readable instructions. The processing element 1101 may be a central processing unit of the computing system 1100. Additionally or alternatively, the processing unit 1101 may be other processors within the device including application specific integrated chips (ASIC) and other microcontroller devices.

The memory 1102 may include a variety of types of non-transitory computer-readable storage media, including, for example, read access memory (RAM), read-only memory (ROM), erasable programmable memory (e.g., EPROM and EEPROM), OTP (One-Time-Programmable) storage, or flash memory. The memory 1102 is configured to store computer-readable instructions, sensor values, and other persistent software elements. Computer-readable media 1103 may also include a variety of types of non-transitory computer-readable storage media including, for example, a hard-drive storage device, a solid state storage device, a portable magnetic storage device, or other similar device. The computer-readable media 1103 may also be configured to store computer-readable instructions, sensor values, and other persistent software elements.

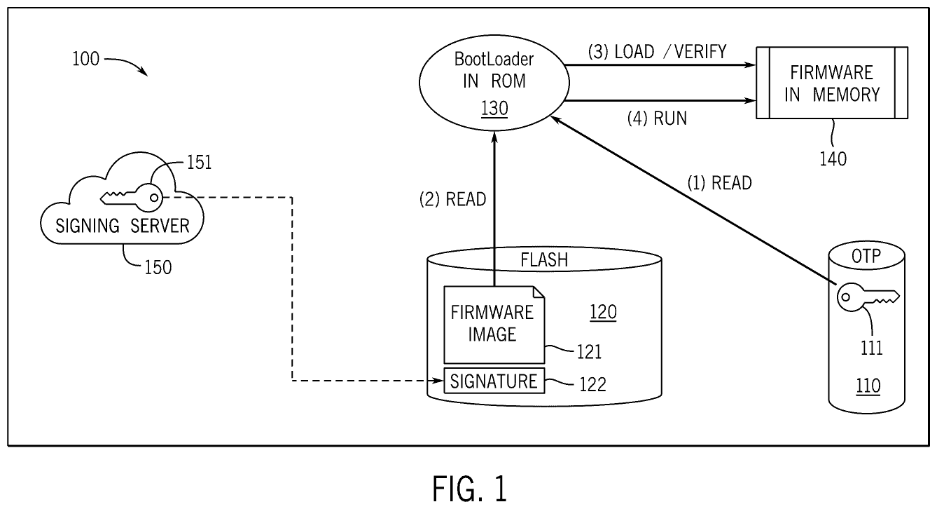

In this example, the processing unit 1101 is operable to read computer-readable instructions stored on the memory 1102 and/or computer-readable media 1103. The computer-readable instructions may adapt the processing unit 1101 to perform the operations or functions described above with respect to FIGS. 1-10. The computer-readable instructions may be provided as a computer-program product, software application, or the like.

Still referring to FIG. 11, the computing system 1100 may also include a display 1104 to display command operations. The display 1104 may include a liquid-crystal display (LCD), organic light emitting diode (OLED) display, light emitting diode (LED) display, or the like. If the display 1104 is an LCD, the display may also include a backlight component that can be controlled to provide variable levels of display brightness. If the display 1104 is an OLED or LED type display, the brightness of the display 1104 may be controlled by modifying the electrical signals that are provided to display elements.

The computing system 1100 may also include a battery 1105 that is configured to provide electrical power to the components of computing system 1100. The battery 1105 may include one or more power storage cells that are linked together to provide an internal supply of electrical power. In this regard, the battery 1105 may be a component of a power source 1105 (e.g., including a charging system or other circuitry that supplies electrical power to components of the computing system 1100). The battery 1105 may be operatively coupled to power management circuitry that is configured to provide appropriate voltage and power levels for individual components or groups of components within the computing system 1100. The battery 1105, via power management circuitry, may be configured to receive power from an external source, such as an AC power outlet or interconnected computing device. The battery 1105 may store received power so that the computing system 1100 may operate without connection to an external power source for an extended period of time, which may range from several hours to several days.

The computing system 1100 may also include a communication port 1106 that is configured to transmit and/or receive signals or electrical communication from an external or separate device. The communication port 1106 may be configured to couple to an external device via a cable, adaptor, or other type of electrical connector. In some embodiments, the communication port 1106 may be used as a transceiver of the computing system 1100, which is configured to send and/or receive analog signals and convert the analog signals from/to digital signals. The communication port 1106 may also be configured to receive identifying information from an external accessory, which may be used to determine a mounting or support configuration. For example, the communication port 1106 may be used to determine that the computing system 1100 is coupled to a mounting accessory, such as a particular type of stand or support structure.

Additionally, it should be understood that other examples and implementations are within the scope and spirit of the disclosed method for performing unlimited secure boot key rotation. For example, the disclosed method of rotating a key by using a secret hardware key can be extended to any device, kernel, module, and operating system for authentication and secure booting purposes. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A method for securely rotating a plurality of boot keys with a hardware key, the method comprising:
generating, by a signing server, a first key pair of the plurality of boot keys, wherein the first key pair includes a first public verification key and a first private signing key;
generating, by the signing server, a first signature by using the first private signing key and a first firmware image;
booting, by a bootloader of an electric device, the electric device to run the first firmware image by using the electric device's first key pair; and
rotating, by the bootloader of the electric device, the first key pair of the plurality of boot keys.

2. The method of claim 1 wherein rotating the first key pair of the plurality of boot keys further comprises:
generating, by the signing server, a second key pair of the plurality of boot keys outside the electric device, wherein the second key pair includes a second public verification key and a second private signing key;
generating, by the signing server, a second signature and a third signature by using the second key pair and a second firmware image, wherein the second signature is associated with the second firmware image;
updating, by the bootloader of the electric device, the first key pair and the first firmware image with the second key pair and the second firmware image;
verifying, by the bootloader of the electric device, the second signature by using the second public verification key; and
loading, by the bootloader of the electric device, the second firmware image.

3. The method of claim 1 wherein booting the electric device to run the first firmware image further comprises further comprises:
storing the first signature, the first firmware image, and the first public verification key into the electric device's storage;
verifying the electric device is set to a secure boot mode;
generating a first message authentication code for the first public verification key by using the hardware key;
storing the first message authentication code into the electric device's storage;
verifying the first signature by using the first public verification key; and
loading the first firmware image to the electric device.

4. The method of claim 1 wherein booting the electric device to run the first firmware image further comprises:
verifying the electric device is set to a secure boot mode;
verifying a first message authentication code for the first public verification key by using the hardware key;
verifying a first signature associated with the first firmware image by using the first public verification key; and
loading the first firmware image to the electric device.

5. The method of claim 2 wherein generating the second signature and the third signature further comprises:
generating the second signature by using the second private signing key and the second firmware image;
generating the third signature by using the second public verification key and the first private signing key;
replacing the first private signing key with the second private signing key;
destroying the first private signing key; and
storing the second signature, the third signature, the second public verification key, and the second firmware image into the electric device's storage.

6. The method of claim 2 wherein updating the first key pair and the first firmware image with the second key pair and the second firmware image further comprises:
rebooting the electric device;
verifying the electric device is set to a secure boot mode;
verifying the first public verification key by using the hardware key and a first message authentication code in the electric device's storage;
verifying the third signature by using the first public verification key;
replacing the first public verification key with the second public verification key;
generating a second message authentication code for the second public verification key by using the hardware key; and
replacing the first message authentication code with the second message authentication code.

7. The method of claim 1 wherein the hardware key is embedded in the electric device's hardware during wafer production.

8. The method of claim 3 wherein the electric device's storage is a read/writable memory medium.

9. The method of claim 6 wherein the first message authentication code and the second message authentication code each is generated by using one of a plurality of algorithms, including hash hash-based message authentication code, one-key message authentication code, cipher-based message authentication code, Galois message authentication code, and parallelizable message authentication code.

10. The method of claim 6 wherein verifying the electric device is set to the secure boot mode further comprises:
setting a first verification bit in a one-time-programmable storage; and
verifying the value of the first verification bit is equal to 1.

11. The method of claim 6 wherein verifying the first message authentication code further comprises:
setting a second verification bit in a one-time-programmable storage;
verifying the value of the second verification bit is equal to 1; and
verifying the first message authentication code with the hardware key.

12. A system for securely rotating a plurality of boot keys with a hardware key, the system comprising:
a signing server configured to generate
a first key pair of the plurality of boot keys comprising a first public verification key and a first private signing key,
a second key pair of the plurality of boot keys comprising a second public verification key and a second private signing key,
a first signature by using the first private signing key and a first firmware image,
a second signature by using the second private signing key and a second firmware image, and
a third signature by using the second public verification key and the first private signing key; and
an electric device comprising a bootloader and a storage configured to rotate the first key pair with the second key pair.

13. The system of claim 12, wherein the signing server is further configured to:
replace the first private signing key with the second private signing key; and
destroy the first private signing key.

14. The system of claim 12, wherein the bootloader is further configured to:
verify the electric device is set to a secure boot mode;
generate a first message authentication code for the first public verification key by using the hardware key;
store the first message authentication code into the electric device's storage;
verify the first signature by using the first public verification key; and
load the first firmware image.

15. The system of claim 12, wherein the bootloader is further configured to:
reboot the electric device;
verify the electric device is set to a secure boot mode;
verify the first public verification key by using the hardware key and a first message authentication code in the electric device's storage;
verify the third signature by using the first public verification key;
replace the first public verification key with the second public verification key;
generate a second message authentication code for the second public verification key by using the hardware key;
replace the first message authentication code with the second message authentication code;
verify the second signature by using the second public verification key; and
load the second firmware image.

16. The system of claim 12 wherein the hardware key is embedded in the electric device's hardware during wafer production.

17. The system of claim 12 wherein the electric device's storage is a read/writable memory medium.

18. The system of claim 15 wherein the first message authentication code and the second message authentication code each is generated by using one of a plurality of algorithms, including hash hash-based message authentication code, one-key message authentication code, cipher-based message authentication code, Galois message authentication code, and parallelizable message authentication code.

19. The system of claim 15 wherein the bootloader is further configured to:
set a first verification bit in a one-time-programmable storage; and
verify the value of the first verification bit is equal to 1.

20. The system of claim 15 wherein the bootloader is further configured to:
set a second verification bit in a one-time-programmable storage;
verify the value of the second verification bit is equal to 1; and
verify the first message authentication code with the hardware key.
